(19) United States
(12) Patent Application Publication
(10) Pub. No.: US 2025/0023905 A1
(43) Pub. Date: Jan. 16, 2025

(54) PREDICTIVE PRIORITIZATION AND ADAPTIVE SECURITY OF INFRASTRUCTURE

(71) Applicant: VMWARE, INC., Palo Alto, CA (US)

(72) Inventors: SIDDHARTH BURLE, Pune (IN); AMIT MEENA, Pune (IN); GEETA GOKHALE, Pune (IN)

(21) Appl. No.: 18/371,469

(22) Filed: Sep. 22, 2023

(30) Foreign Application Priority Data
Jul. 14, 2023 (IN) 202341047608

(51) Int. Cl. H04L 9/40

(52) U.S. Cl. CPC H04L 63/1441; H04L 63/1416; H04L 63/1433

(57) ABSTRACT

Techniques associated with adaptive infrastructure security are disclosed. Information regarding a plurality of threat events from one or more source systems is received. For each of the plurality of threat events, a probability of a target system being exploited can be computed. A threat event can be selected at a first time from the plurality of threat events associated with a first probability that meets a threshold. Remedial actions performed to address the threat event at a respective source system can be received, and a guardrail to apply to the target system can be determined based on the remedial actions. The guardrail can then be applied to the target system.

### RELATED APPLICATIONS

Benefit is claimed under 35 U.S.C. 119 (a)-(d) to Foreign application No. 202341047608 filed in India entitled “PREDICTIVE PRIORITIZATION AND ADAPTIVE SECURITY OF INFRASTRUCTURE”, on Jul. 14, 2023, by VMware, Inc., which is herein incorporated in its entirety by reference for all purposes.

The present application (Attorney Docket No. J062.01) is related in subject matter to U.S. Pat. No. ______ (Attorney Docket No. J062.02) which is incorporated herein by reference.

Software defined networking (SDN) involves a plurality of hosts in communication over a physical network infrastructure of a data center (e.g., an on-premises data center or a cloud data center). The physical network to which the plurality of physical hosts is connected may be referred to as an underlay network. Each host has one or more virtualized endpoints, such as virtual machines (VMs), containers, Docker containers, data compute nodes, isolated user space instances, namespace containers, and/or other virtual computing instances (VCIs), which are connected to, and may communicate over, logical overlay networks. For example, the VMs and/or containers running on the hosts may communicate with each other using an overlay network established by hosts using a tunneling protocol.

A container is a package that relies on virtual isolation to deploy and run applications that access a shared operating system (OS) kernel. Containerized applications, also referred to as containerized workloads, can include a collection of one or more related applications packaged into one or more groups of containers, referred to as pods.

Containerized workloads may run with a container orchestration platform that automates much of the operational effort required to run containers with workloads and services. This operational effort includes a wide range of things needed to manage a container's lifecycle, including, but not limited to, provisioning, deployment, scaling (e.g., up and down), networking, and load balancing. Kubernetes® (K8S®) software is an example open-source container orchestration platform that automates the operation of such containerized workloads. A container orchestration platform may manage one or more clusters, such as a K8S cluster, including a set of nodes that run containerized applications.

As part of an SDN, any arbitrary set of VCIs in a data center may be placed in communication across a logical Layer 2 (L2) overlay network by connecting them to a logical switch. A logical switch is an abstraction of a physical switch collectively implemented by a set of virtual switches on each node (e.g., host machine or VM) with a VCI connected to the logical switch. The virtual switch on each node operates as a managed edge switch implemented in software by a hypervisor or operating system (OS) on each node. Virtual switches provide packet forwarding and networking capabilities to VCIs running on the node. In particular, each virtual switch uses hardware-based switching techniques to connect and transmit data between VCIs on a same node or different nodes.

A pod may be deployed on a single VM or a physical machine. The single VM or physical machine running a pod may be referred to as a node running the pod. From a network standpoint, containers within a pod share the same network namespace, meaning they share the same internet protocol (IP) address or IP addresses associated with the pod.

A network plugin, such as a container networking interface (CNI) plugin, may be used to create virtual network interface(s) usable by the pods for communicating on respective logical networks of the SDN infrastructure in a data center. In particular, the network plugin may be a runtime executable that configures a network interface, referred to as a pod interface, into a container network namespace. The network plugin is further configured to assign a network address (e.g., an IP address) to each created network interface (e.g., for each pod) and may also add routes relevant to the interface. Pods can communicate with each other using their respective IP addresses. For example, packets sent from a source pod to a destination pod may include a source IP address of the source pod and a destination IP address of the destination pod so that the packets are appropriately routed over a network from the source pod to the destination pod.

Communication between pods of a node may be accomplished through use of virtual switches implemented in nodes. Each virtual switch may include one or more virtual ports (Vports) that provide logical connection points between pods. For example, a pod interface of a first pod and a pod interface of a second pod may connect to Vport(s) provided by the virtual switch(es) of their respective nodes to allow for communication between the first and second pods. In this context, “connect to” refers to the capability of conveying network traffic, such as individual network packets or packet descriptors, pointers, or identifiers, between components to effectuate a virtual data path between software components.

Security for such an infrastructure is important. However, the complexity of the infrastructure can make it difficult to manage and govern security policies.

### SUMMARY

One or more embodiments of a method for recommending and applying guardrails, such as, but not limited to, VMware Aria Guardrails, are disclosed. The method comprises receiving information regarding two or more threat events that occurred at one or more source systems; computing, for each of the two or more threat events, a probability of a target system being exploited by the threat event; selecting, at a first time, a first threat event from the two or more threat events, the first threat event associated with a first probability that meets a threshold; receiving information regarding one or more remedial actions performed to address the first threat event at a respective source system where the first threat event occurred; determining, based on the one or more remedial actions, a guardrail to apply to the target system; and applying the guardrail to the target system.

Further embodiments include one or more non-transitory computer-readable storage media storing instructions that, when executed by one or more processors of a computer system, cause the computer system to perform any of the methods set forth herein, and a computer system including at least one processor and memory configured to carry out any of the methods set forth herein.

### BRIEF DESCRIPTION OF THE DRAWINGS

FIG. 1 illustrates a computing system in which embodiments described herein may be implemented.

FIG. 2 is a block diagram of an example guardrail recommendation system according to an example embodiment of the subject disclosure.

FIG. 3 is a flow chart diagram of an example method of guardrail recommendation, according to an example embodiment of the subject disclosure.

FIG. 4 is a flow chart diagram of an example method of training a machine learning model, according to an embodiment of the subject disclosure.

FIG. 5 is a block diagram of an example adaptive privilege system, according to an example embodiment of the subject disclosure.

To facilitate understanding, identical reference numerals have been used, where possible, to designate identical elements that are common to the figures. It is contemplated that elements disclosed in one embodiment may be beneficially utilized in other embodiments without specific recitation.

### DETAILED DESCRIPTION

Many organizations are running business-critical workloads in virtualized environments. Further, many workloads are executed on a single physical host. If an attacker compromises a physical host, the attacker may have access to many workloads and not just a single traditional physical server. Accordingly, security in virtualized environments is important.

High volumes of vulnerabilities, misconfiguration leading to a security risk, growing attack surface, and limited time and resources are significant problems for virtualized environments. Furthermore, vulnerabilities are becoming increasingly complex, voluminous, and severe as the attack surface grows with clouds, containers, microservices, and Internet of Things (IoT) devices.

Guardrails are an effective tool for implementing a reinforced security posture. Guardrails enforce the security posture continually and ensure that misconfiguration does not lead to vulnerability in virtual environments including on-premises and cloud environments. In other words, guardrails ensure that a desired state is maintained over time.

Traditionally, guardrails are static rule-based enforcement of best practices associated with various security standards. Guardrails are also manually authored, for example, by administrators. With an ever-growing threat landscape, change happens frequently and dynamically in virtual environments. Accordingly, statically configured guardrails may be unable to cope, for example, with configuration sprawl and the associated ever-increasing attack surface.

Aspects of the subject disclosure pertain to predicting, generating, recommending, and applying guardrails based on thread remediation and context. The definition and application of these guardrails can be dynamic and adaptive to address the changing threat landscape. Further, predictive prioritization can be utilized to identify and address vulnerabilities that matter the most. In other words, vulnerabilities can be prioritized for what should be addressed today instead of tomorrow or later. A probability or likelihood that a threat actor will exploit a vulnerability can be determined based on at least threat intelligence across one or more sources. If the probability exceeds a threshold, a guardrail can be selected or generated and applied dynamically while also considering entity context. By prioritizing and automatically applying adaptive guardrails, a desired state can be maintained in accordance with one or more policies.

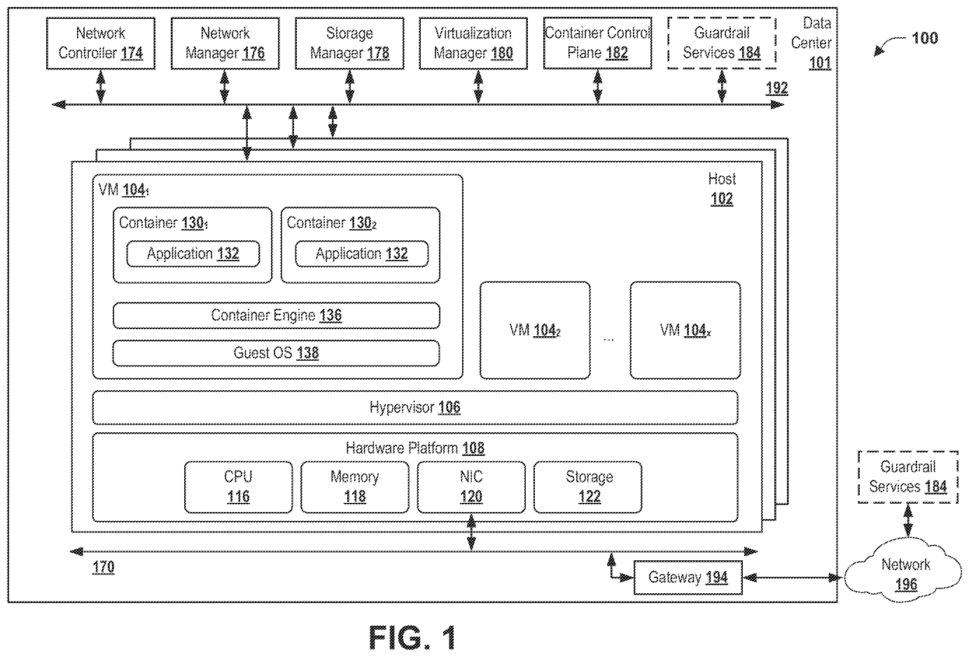

FIG. 1 depicts examples of physical and virtual network components in a networking environment 100 where embodiments of the subject disclosure may be implemented.

Networking environment 100 includes a data center 101. Data center 101 includes one or more hosts 102, a management network 192, a data network 170, a network controller 174, a network manager 176, storage manager 178, virtualization manager 180, container control plane 182, and guardrail services (or system) 184. Data network 170 and management network 192 may be implemented as separate physical networks or as separate virtual local area networks (VLANs) on the same physical network. Further, the data center 101 includes gateway 194, enabling communication outside the data center 110 over network 196 (e.g., Internet, Intranet) to access guardrail services 184 externally in an additional or alternative embodiment.

Host(s) 102 may be communicatively connected to data network 170 and management network 192. Data network 170 and management network 192 are also referred to as physical or “underlay” networks, and may be separate physical networks or the same physical network as discussed. As used herein, the term “underlay” may be synonymous with “physical” and refers to physical components of networking environment 100. As used herein, the term “overlay” may be used synonymously with “logical” and refers to the logical network implemented at least partially within networking environment 100.

Host(s) 102 may be geographically co-located servers on the same rack or different racks in any arbitrary location in the data center. Host(s) 102 may be configured to provide a virtualization layer, also referred to as a hypervisor 106, that abstracts processor, memory, storage, and networking resources of a hardware platform 108 into multiple VMs 104₁-104ₓ (collectively referred to herein as “VMs 104” and individually referred to herein as “VM 104”).

Host(s) 102 may be constructed on a server-grade or commodity hardware platform 108, such as an x86 architecture platform. Hardware platform 108 of a host 102 may include components of a computing device such as one or more processors (CPUs) 116, system memory 118, one or more network interfaces (e.g., physical network interface cards (PNICs) 120), storage 122, and other components (not shown). A CPU 116 is configured to execute instructions, for example, executable instructions that perform one or more operations described herein and that may be stored in memory 118 and storage 122. The network interface(s) 120 enable host 102 to communicate with other devices through a physical network, such as management network 192 and data network 170.

Each VM 104 implements a virtual hardware platform that supports the installation of a guest OS 138, which is capable of executing one or more applications. Guest OS 138 may be a standard commodity operating system. Examples of a guest OS include Microsoft Windows®, Linux®, or the like.

Each VM 104 may include a container engine 136 installed therein and running as a guest application under the control of guest OS 138. Container engine 136 is a process that enables the deployment and management of virtual instances (referred to interchangeably herein as “containers”) by providing a layer of OS-level virtualization on guest OS 138 within VM 104 or an OS of host 102. Containers 130 are software instances that enable virtualization at the OS level. With containerization, the kernel of guest OS 138, or an OS of host 102 if the containers are directly deployed on the OS of host 102, is configured to provide multiple isolated user-space instances, referred to as containers. Containers 130 appear as unique servers from the standpoint of an end user that communicates with each of containers 130. However, from the standpoint of the OS on which the containers execute, the containers are user processes that are scheduled and dispatched by the OS.

Containers 130 encapsulate an application, such as application 132, as a single executable software package that bundles application code with all the related configuration files, libraries, and dependencies required to run. Application 132 may be any software program, such as a word processing program or a gaming server.

Data center 101 includes a container control plane 182. In certain aspects, the container control plane 182 may be a computer program that resides and executes in one or more central servers, which may reside inside or outside the data center 101, or alternatively, may run in one or more VMs 104 on one or more hosts 102. A user can deploy containers 130 through container control plane 182. Container control plane 182 is an orchestration control plane, such as Kubernetes®, to deploy and manage applications or services thereof on nodes, such as hosts 102 or VMs 104, of a node cluster, using containers 130. For example, Kubernetes may deploy containerized applications as containers 130 and a container control plane 182 on a cluster of nodes. The container control plane 182, for each cluster of nodes, manages the computation, storage, and memory resources to run containers 130. Further, the container control plane 182 may support the deployment and management of applications (or services) on the cluster using containers 130. In some cases, the container control plane 182 deploys applications as pods of containers 130 running on hosts 102, either within VMs 104 or directly on an OS of the host 102. Other types of container-based clusters based on container technology, such as Docker® clusters, may also be considered.

Data center 101 includes a network management plane and a network control plane. The management plane and control plane each may be implemented as single entities (e.g., applications running on a physical or virtual compute instance) or as distributed or clustered applications or components. In alternative aspects, a combined manager/controller application, server cluster, or distributed application may implement both management and control functions. In the embodiment shown, network manager 176 at least in part implements the network management plane, and network controller 174 and container control plane 182 in part implements the network control plane.

The network control plane is a component of software defined network (SDN) infrastructure and determines the logical overlay network topology and maintains information about network entities such as logical switches, logical routers, and endpoints. The logical topology information is translated by the control plane into physical network configuration data that is then communicated to network elements of host(s) 102. Network controller 174 generally represents a network control plane that implements software defined networks, e.g., logical overlay networks, within data center 101. Network controller 174 may be one of multiple network controllers executing on various hosts in the data center that together implement the functions of the network control plane in a distributed manner. Network controller 174 may be a computer program that resides and executes in a server in data center 101, external to data center 101 (e.g., such as in a public cloud) or, alternatively, network controller 174 may run as a virtual appliance (e.g., a VM) in one of hosts 102. Network controller 174 collects and distributes information about the network from and to endpoints in the network. Network controller 174 may communicate with hosts 102 over management network 192, such as through control plane protocols. In certain aspects, network controller 174 implements a central control plane (CCP) that interacts and cooperates with local control plane components, such as agents, running on hosts 102 in conjunction with hypervisor 106.

Network manager 176 is a computer program that executes in a server in networking environment 100, or alternatively, network manager 176 may run in a VM 104, such as in one of hosts 102. The network manager 176 communicates with host(s) 102 over management network 192. Network manager 176 may receive network configuration input from a user, such as an administrator, or an automated orchestration platform (not shown) and generate desired state data that specifies logical overlay network configurations. For example, a logical network configuration may define connections between VCIs and logical ports of logical switches. Network manager 176 is configured to receive inputs from an administrator or other entity, e.g., via a web interface or application programming interface (API), and carry out administrative tasks for data center 101, including centralized network management and providing an aggregated system view for a user.

The virtualization manager 180 is a computer program that executes in a server in networking environment 100. The virtualization manager 180 enables management, administration, and control of virtualized environments. The virtualization manager 180 provides a range of functionalities including provisioning and deploying VMs 104, monitoring resource utilization, and managing storage and network configuration, among other things. Administrators can utilize the virtualization manager 180 to allocate and manage computing resources and optimize performance across a virtualized infrastructure.

Guardrail services 184 correspond to a service or system that implements guardrails as described herein including static and dynamic guardrails. A guardrail is a high-level concept that specifies a security or compliance objective and comprises one or more policies associated with on-premises or cloud infrastructure. A policy comprises a set of rules that define desired behavior or configuration, including what is allowed or prohibited. Rules define specific actions, configurations, or restrictions to follow to comply with the policy. For example, a rule within a policy can indicate that a virtual switch address should not be changed, which could be at least a portion of a network configuration policy associated with a guardrail specifying best practices for managing network devices. A static guardrail is manually authored, for example, by an administrator. A dynamic guardrail is automatically generated, for instance, based on a threat remedy and context. The guardrail services 184 are configured to support generation and enforcement of guardrails to ensure an infrastructure (e.g., cloud service, data center) maintains a desired state defined by one or more guardrails. Further, the guardrail services 184 can reside inside or outside the data center 101. Inside the data center 101, the guardrail services 184 can utilize the management network 192 to interact with the host 102. The guardrail services 184 outside the data center 101 can access the host 102 through network 196, gateway 194, and data network 170 or management network 192, where gateway 194 is also coupled to the management network 192. Guardrail services 184 may be one or more processes running on one or more computing devices (e.g., physical computing devices, VCIs, etc.).

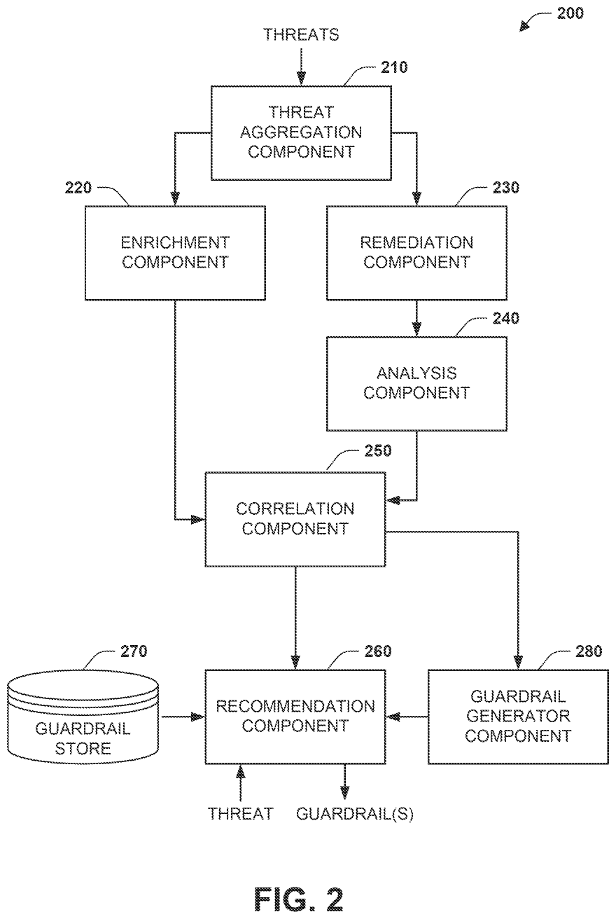

FIG. 2 is a block diagram of a guardrail system 200 to recommend a guardrail for application. The guardrail system 200 includes several components, including threat aggregation component 210, enrichment component 220, remediation component 230, analysis component 240, correlation component 250, recommendation component 260, guardrail store 270, and guardrail generator component 280, which each may be one or more processes running on one or more computing devices (e.g., physical computing devices, VCIs, etc.). The guardrail system 200 may be part of guardrail services 184 of FIG. 1. The guardrail system 200 receives a threat as input and outputs one or more guardrails that can subsequently be applied to a corresponding resource or group of resources to ensure a desired state specified by the one or more guardrails. The resource or group or resources may refer to any components of data center 101, such as hosts 102, containers 130, VMs 104, virtual switches, virtual routers, gateways, etc.

The threat aggregation component 210 is configured to receive, retrieve, or otherwise obtain or acquire threat events. Threat events can originate from various sources including cloud provider security components and security organizations, among others. A threat event can refer to an incident or occurrence that has the potential to compromise the security of systems, networks, or digital assets involving actions of threat actors, such as hackers, cybercriminals, or malicious insiders, that seek to exploit vulnerabilities in a target system to carry out harmful activities. Threat events can take various forms including, but not limited to, malware (e.g., viruses, worms, trojans, ransomware) infections, data breaches, disinformation, supply chain attacks, and social engineering attacks. In certain embodiments, the threat aggregation component 210 can monitor and receive threat events through a threat event stream.

By way of example, and not limitation, the threat aggregation component 210 can receive threat events as input from various sources through a feed. In this example, threat events can be provided from three sources the National Institute of Standards and Technology (NIST), a knowledge base of cybersecurity threats (MITRE), and a cloud service provider (AWS). Each threat event identifies a source, common vulnerability and exposure (CVE) identifier, description, and reference web address as follows:
Source: NIST
CVE-ID: CVE-2021-1234
Description: A vulnerability in the application allows remote attackers to execute arbitrary code.
References:
https://xxxxxx
Source: MITRE
CVE-ID: CVE-2022-5678
Description: The software does not properly validate user input, leading to a SQL injection vulnerability.
References:
https://xxxxx
Source: AWS
CVE-ID: CVE-2023-9012
Description: A vulnerability in Amazon S3 allows unauthorized access to private objects.
References:
https://xxxxx
   After receipt of these threat events and associated information, the threat aggregation component can aggregate and output the event threat data in a normalized form for subsequent processing. For instance, a sequence or array of threat events or CVEs can be output as follows:

{
“CVEs”: [
{
“source”: “NIST”,
“CVE-ID”: “CVE-2021-1234”,
“description”: “A vulnerability in the
application allows remote attackers to
execute arbitrary code.”,
“references”: [
“https://xxxxx”
]
},
{
“source”: “MITRE”,
“CVE-ID”: “CVE-2022-5678”,
“description”: “The software does not
properly validate user input, leading to a
SQL injection vulnerability.”,
“references”: [
“https://xxxxx”
]
},
{
“source”: “AWS”,
“CVE-ID”: “CVE-2023-9012”,
“description”: “A vulnerability in
Amazon S3 allows unauthorized access to
private objects.”,
“references”: [
“https://xxxxx”
]
}
]
}

The enrichment component 220 is configured to enrich threat events. Enrichment refers to a process of enhancing information associated with a specific threat event. Enriching a threat event can involve adding contextual details, metadata, or intelligence to support a deeper understanding of the threat event and its impact. Data used to enrich threat events can come from various sources, internal or external to a system (e.g., data center), including threat intelligence feeds, security systems and tools, and logs, among others.

Various techniques and mechanisms can be employed to enrich an event. In one embodiment, a term frequency representation of a threat event and associated metadata can be generated, where the representation is a numerical vector that captures the frequency distribution of terms/words describing the event. The term frequency representation can provide information regarding keywords, patterns, or combinations of terms specific to a threat event or attack technique, which can contribute to enriching the threat event. In accordance with another embodiment, a configuration management database (CMDB) or another centralized repository can aid threat event enrichment by providing contextual information about assets and configurations about where the threat event occurred and the scope within a system (e.g., clusters, pods, applications, services) that can directly or indirectly be affected by the threat event (e.g., blast radius) In accordance with another embodiment, malware analysis can provide enrichment data in the context of security.

A threat event, such as the threat event from the AWS source in the preceding example, can be enriched with context data added to a tag set of the threat event. For instance, context data can correspond to resource type, cloud type, vulnerability type, application, business unit, team, and service. Additional context can be specified with respect to a resource signature, such as entity type, resource name, region, and ownership controls, as shown:

{
“source”: “AWS”,
“CVE-ID”: “CVE-2023-9012”,
“description”: “A vulnerability in
Amazon S3 allows unauthorized access to
private objects.”,
...
],
“tagSets”: [
{“resourceType”: “cloudStorage”},
{“cloudType”: “AWS”},
{“vulnerabilityType”: “CVE},
{“app”: “Customer Connect”},
{“businessUnit”: “CMBU”},
{“team”: “Customer Connect”},
{“service”: [
“Customer Connect backend”,
“Customer connect messaging”]}
],
“resourceSignature”: “entityType = AWS.S3.
Bucket AND resource name = AWS.S3.
011922870716.us-east-1.Bucket.ariahubtest1
AND AWS.S3.Bucket.BlockPublicAcls = true AWS.
S3.Bucket.BlockPublicPolicy = true AND AWS.
S3.assignedRegion = us-east-1 AND
OwnershipControls = [‘BucketOwnerEnforced’]
AND ReplicationEnabled = false AND
RestrictPublicBuckets = true AND
StaticWebsiteEnabled = false AND
VersioningMFADelete = Disabled AND
VersioningStatus = Enabled ”
}
}

Threat event enrichment can aid in prioritization of threat events as well as guardrail selection or generation to maintain the desired state. For example, consider events generated from a vulnerability management tool that are not on the internet and are instead in a playground account. In this situation, guardrails will not be applied, which helps prevent guardrail sprawl by applying guardrails solely to accounts that are vulnerable and critical or high priority. Further, events from different sources can be normalized to use a consistent format to make deduplication and correlation much simpler. For example, if an event uses internet protocol (IP) addresses as a source while another uses domain names, enrichment can be performed to ensure all events are configured consistently. Enrichment data or context can be output by the enrichment component 220.

The remediation component 230 is configured to receive, retrieve, or otherwise obtain or acquire remediation action associated with a threat event. The remediation can correspond to manual, automatic, or semi-automatic remediation, such as by an administrator or remediation tool or system (e.g., AWS security hub, Azure security center, in-house tools). In certain embodiments, remediation can correspond to one or more static guardrails, which can be utilized with respect to similar accounts or systems in the same or a different organization.

The analysis component 240 is configured to analyze and capture information about the remediation action. For instance, the analysis component 240 can acquire time series configuration history around a target account, wherein a target account is a specific user account or privileged account of interest to threat actors as they provide access to sensitive information and the ability to perform critical actions within a system or network. The time series history can include what actions were performed at what times, what configurations were changed, etc., for an account, system, or deployment where remediation was performed for the threat. Further, the analysis component 240 can identify new checks implemented, new guardrails created, or new configuration changes created to thwart the effects of a threat event.

In the ongoing example, suppose the threat event from the AWS source has been remediated. The analysis component 240 can update the threat event to include remediation information, among other things. In this instance, the threat event is remediated by applying two guardrails, as captured below.

{
“source”: “AWS”,
“CVE-ID”: “CVE-2023-9012”,
“description”: “A vulnerability in Amazon
S3 allows unauthorized access to private
objects.”,
“references”: [
“https://xxxxx
],
“cloudType”: “AWS”,
“Region”: “Global”,
“lookupTags”: “awsS3”,
“guardrailsApplied”: [
“OOTB S3 readOnly”,
“OOTB SCP for S3 policy change
restriction”
]
}

The correlation component 250 is configured to receive enrichment data and captured data from the analysis component 240 associated with a threat event and correlate the data. The correlation component 250 can collect and correlate data associated with different circumstances regarding the same event as well as different events. The correlation component 250 can format and organize data in a manner conducive to machine learning. In other words, the correlation component 250 can output training data for training, retraining, or updating one or more machine learning models.

By way of example, and not limitation, the correlation component 250 can output the following recommendation associated with the AWS source ongoing example. This recommendation can be utilized to train a recommendation model.

```
{
“recommendation”: {
“message”: “A vulnerability has been discovered in an S3 bucket that allows unauthorized access
to private objects. This poses a security risk and should be addressed immediately.”,
    “actions”: [
      “OOTB SCP for S3 policy change restriction”
    ],
    “severity”: “High”,
    “recommendationId”: “RECO-2023-001”,
    “resources”: [
        {
          “resourceType”: “AWS.S3.Bucket”,
          “resourceName”: “AWS.S3.991922870716.
us-west-1.Bucket.somerandombucket”,
          “region”: “us-west-1”
          }
    ]
  }
}
```

The recommendation component 260 is configured to receive a potential threat event and recommend one or more guardrails to thwart the impact of the threat event. In accordance with one embodiment, the recommendation component 260 can be a machine learning model trained with data from the correlation component. Based on the threat event, the recommendation component 260 can recommend or suggest previously generated guardrails or guardrail templates in the persistent guardrail store or repository 270. In one embodiment, if automatic recommendation enforcement can be enabled (as opposed to disabled), recommended guardrails can be automatically applied.

The guardrail generator component 280 is configured to automatically generate one or more guardrails for a particular threat event. In one embodiment, the guardrail generator component 280 can be a machine learning model trained with data from the correlation component 250. In one embodiment, the recommendation component 260 can invoke the guardrail generator component 280 if no previously generated guardrail satisfies a threshold probability of being able to thwart the effects of the threat event and return the generated guardrail as the recommendation. Alternatively, the guardrail generator component 280 can return one or more guardrails to the recommendation component for consideration for recommendation in conjunction with previously generated guardrails in the guardrail store 270.

Continuing with the prior example, supposed the recommendation component 260 receives a threat event that matches or is substantially similar to the threat from AWS associated with a vulnerability in Amazon simple storage service (S3) that allows unauthorized access to private objects. Having been trained on this example, the recommendation component 260 can select and recommend one or more guardrails used to remediate the threat event, such as a guardrail specifying a service control policy (SCP) restricting access to Amazon S3.

In accordance with another embodiment, the recommendation component 260 can recommend not responding based on a risk assessment and the probability that the threat event will occur. In this manner, guardrail sprawl can be limited. In one embodiment, the recommendation component 260 can include or invoke a second machine-learning model associated with this prediction. In accordance with an embodiment, a predicted risk score can be computed that captures risk and likelihood that a threat actor will employ a particular threat event, namely a predictive risk score. Factors that can be considered for the predictive risk score include a vulnerability assessment tool (VAT) score for the threat event, common vulnerability scoring system (CVSS) score for the threat event, asset score (e.g., business context) for the threat event, social media score for the threat event resulting from analysis of a crawl of social media, the dark web, or the deep web, and a score for the threat event from a national vulnerability database (NVD). The predictive risk score can be computed as a weighted sum of each factor.

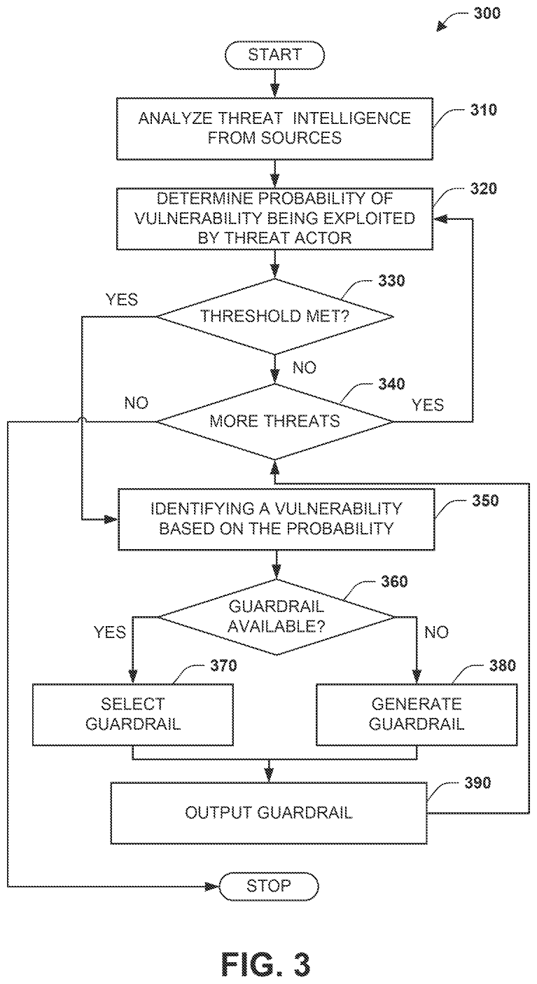

FIG. 3 depicts an example method 300 of guardrail recommendation. The method 300 can be performed by the recommendation component 260 in conjunction with the guardrail generator 280 in FIG. 2. In block 310, threat intelligence from one or more sources is analyzed. The analysis can seek to identify a threat event or set of threat events from sources. Further analysis can focus on acquiring additional information regarding a threat event, such as one or more metrics classifying the risk posed by a threat event.

In block 320, a probability is determined that represents whether a system vulnerability will be exploited by a threat actor with the threat event. In certain embodiments, a machine learning model can be employed to make such a prediction. The determination can be based on characteristics of the potential threat event and a target system for which it is determined whether or not to apply one or more guardrails to address the potential threat event. In one embodiment, the determination can be based on predictive risk or a predictive risk score. A predictive risk score can be calculated as the weighted sum of metrics representing risk factors. In one instance, a vulnerability assessment test score associated with a target system can be a metric. In another instance, a common vulnerability scoring system (CVSS) can provide a metric. Other example metrics can include a social media score that captures security implications that arise from social media presence, an asset score that represents the value or criticality of an asset within an organization's infrastructure, and a dark web score based on information in an illegal or unregulated environment. Other data that can be considered include content from the national vulnerability database, a comprehensive repository of information about known vulnerabilities in software and hardware products. The probability can thus consider the nature of the potential threat and target system in capturing the likelihood that a threat actor will exploit a vulnerability. Furthermore, the probability or predictive risk score can aid in prioritizing threats.

In block 330, a determination is made as to whether or not the probability meets a threshold for a response. In accordance with one embodiment, a threat event can be selected at a first time from two or more threat events associated with a first probability that meets a threshold. In accordance with another embodiment, a second thread event can be selected, at a second time later than the first, from two or more threat events associated with a second probability that is less than the first. In other words, threat prioritization can be controlled based on a threshold. If the threshold is not satisfied (“NO”), the method proceeds at block 340. If the threshold is met (“YES”), the method continues to block 350. Further, in certain aspects, threat events with a higher probability of exploiting a vulnerability of a system may be handled prior to threat events with a lower probability of exploiting a vulnerability of a system, so as to provide timely security for threat events more likely to exploit a vulnerability of the system. For example, guardrails for higher probability threat events may be determined and applied to the system prior to guardrails for lower probability threat events being determined and applied to the system.

In block 340, a determination is made as to whether there are more threats to consider. If there are more potential threat events (“YES”), the method reverts to block 320 for a different threat event. The method can terminate if there are no more potential threat events (“NO”).

In block 350, a vulnerability associated with a threat event is identified. The vulnerability may be provided or determined based on threat intelligence from multiple sources. Additionally or alternatively, a vulnerability can be predicted or inferred based on information surrounding the threat. In one embodiment, the vulnerability can be identified based on remedial actions performed to address the threat event at a system at which the threat event occurred.

In block 360, a determination is made as to whether a guardrail is available to address the potential threat event. In one instance, a guardrail may be available if it was previously manually generated to address the threat event or a similar threat event. If a guardrail is available (“YES”), the method continues at block 370, where the guardrail is selected. If a guardrail is unavailable (“NO”), the method continues at block 380.

In block 370, a pre-existing guardrail is selected that is likely to thwart and attack. In accordance with one embodiment, a machine learning model trained on remediation data associated with historic threat events can be invoked to select the guardrail.

In block 380, a guardrail is generated automatically or semi-automatically (e.g., with human input). According to one embodiment, a machine learning model can be trained to generate guardrails or templates that address a potential threat event. For example, the machine learning model can be trained on historical threats and corresponding remediation and guardrails put in place to address the threat. The machine learning model can then predict one or more guardrails associated with a new threat event based on responses to past threat events.

In block 390, a selected or generated guardrail can be output. The output can provide a guardrail. Additionally or alternatively, application of the guardrail can be triggered or performed. Subsequently, the method can revert to block 340, where a determination is made as to whether there are more threats to process.

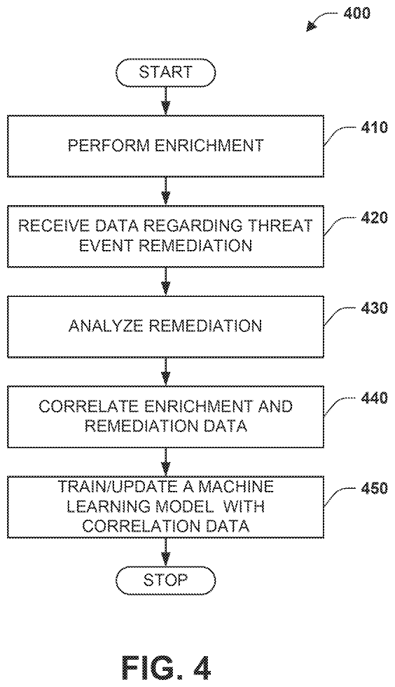

FIG. 4 is a flow chart diagram of an example method 400 of training a machine learning model. The method 400 can be performed by the threat aggregation component 210, enrichment component 220, remediation component 230, analysis component 240, and correlation component 250 of FIG. 2.

In block 410, enrichment is performed, such as discussed with respect to enrichment component 220. Enrichment refers to collecting data regarding system events to gather information about associated clusters, applications, services, locations, teams, and other data from a configuration management database to define relationships between different nodes and understand a blast radius, among other things. Enrichment data prevents guardrail sprawl, in which many guardrails are specified to cover nearly every possible scenario.

In block 420, data regarding threat event remediation is received, retrieved, or otherwise obtained or acquired. Threat event remediation can be performed manually, automatically, or semi-automatically (e.g., with human input). For example, an administrator can manually specify remediation, or remediation can be determined automatically or semi-automatically with a security tool. Remediation can involve invoking particular processes to patch a resource, one or more guardrails, or both. The data received can correspond to these processes and guardrails.

In block 430, the remediation data is analyzed. For example, the remediation data can be searched for specified guardrails. Further, a patch process can be analyzed to identify portions of a resource or set of resources affected by the threat.

In block 440, enrichment and remediation data are correlated or otherwise combined. In one embodiment, the correlation of data is used to generate training data for machine learning.

In block 450, a machine learning model is trained, retrained, or updated with the correlated data. The machine learning model can be trained to recommend guardrails from historical guardrails. Additionally or alternatively, the machine learning model can be trained to generate guardrails. In accordance with certain embodiments, the machine learning models alone or in combination can seek to prioritize guardrails in terms of impact as well as system vulnerabilities such that guardrail recommendation and application focuses on what is most important first and least important last or not at all.

It should be understood that, for any process described herein, there may be additional or fewer steps performed in similar or alternative orders, or in parallel, within the scope of the various embodiments, consistent with the teachings herein, unless otherwise stated.

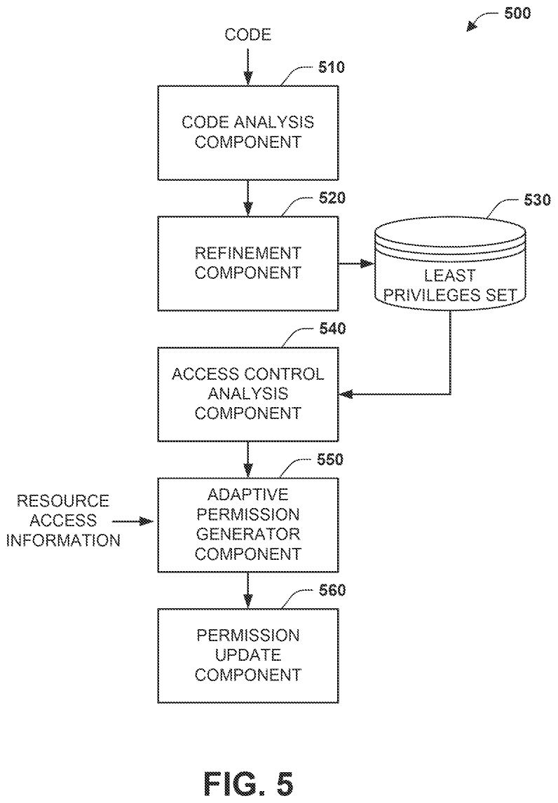

FIG. 5 depicts an example adaptive privilege system 500 per an example embodiment of the subject disclosure. The system 500 is configured to dynamically and automatically associate a least privilege access role to an entity to ensure the entity does not have access to more resources than needed in a data center. An entity may be a user, account, business unit, etc., that accesses one or more resources of the data center, such as by using one or more applications (e.g., microservices) that access the one or more resources. The access role defines privileges indicating what resources the entity can access and what types of access (read, write, modify, etc.) the entity has for those resources. In certain aspects, an entity has more privileges than are needed for the entity to perform the tasks required to be performed by the entity. For example, the access role defined for the entity may indicate that the entity has privilege to access resources that the entity does not actually need to access. In certain aspects, the access role may have more privileges than are needed for the entity due to permission creep. For example, at a first time, the entity may need certain privileges to access a first set of resources, and therefore such privileges are granted in the access role. At a later time, such as if the entity changes job positions or works on a new project, the entity may need certain privileges to access a second set of resources, and therefore such privileges are added to the access role. However, the entity may no longer need to access the first set of resources, and therefore, the entity has more privileges than needed. A least privilege access role may be an access role for an entity where the access role provides only privileges needed by the entity to perform the tasks required to be performed by the entity, and no additional privileges.

In an example embodiment, the adaptive privilege system 500 can be implemented as part of the guardrail services 184 of FIG. 1. Alternatively, the system 500 can be implemented as part of a manager, such as the network manager 176, or a separate permissions manager. The adaptive privilege system 500 includes code analysis component 510, refinement component 520, least privilege set repository 530, access control analysis component 540, adaptive permission generator component 550, and permission update component 560, which may be one or more processes running on one or more computing devices (e.g., physical computing devices, VCIs, etc.).

In certain aspects, adaptive privilege system 500 is used to generate an initial least privilege access role for an entity. For example, the adaptive privilege system 500 may be used to determine, for one or more applications (e.g., microservices) running in a data center, the least privileges needed for each of the one or more applications to operate. Further, the adaptive privilege system 500 may determine, for an entity, which of the one or more applications the entity accesses (such as based on a role of the entity). The adaptive privilege system 500 may accordingly generate an initial least privilege access role for the entity that is a union of the least privileges needed for each of the one or more applications the entity accesses.

In certain aspects, the adaptive privilege system 500 further refines the initial least privilege access role for an entity. For example, the adaptive privilege system 500 monitors actual access of resources by the entity, and further add/removes privileges to the least privilege access role of the entity, based on the actual access of resources by the entity over time.

For example, the code analysis component 510 is configured to receive and analyze code. For example, a developer can check-in application (e.g., microservice) code. Upon or after receipt, the code analysis component 510 can perform static analysis to determine the least privileges required for the code to be functional. For example, the code analysis component 510 determines what resources are accessed by the application and determines privileges needed to access such resources.

The refinement component 520 is configured to refine the least privileges identified by the code analysis component 510. In accordance with one embodiment, the least privileges are refined and tuned by executing functional validation test cases of the application. In certain embodiments, refinement can be performed through continuous integration and continuous deployment (CI/CD) integrated automation. For example, an instance of the application may be actually executed, and the execution monitored to determine what resources the application accesses. In some cases, where resources are accessed by the application for which there is no privilege included in the least privileges generated by code analysis component 510, privileges to access such resources may be added to the least privileges. In some cases, where resources are not accessed by the application for which there is a privilege included in the least privileges generated by code analysis component 510, privileges to access such resources may be removed from the least privileges. The refinement component 520 can also save the least privileges set for the code/application to a persistent store or repository 530 for subsequent processing.

The access control analysis component 540 is configured to determine an initial least privilege access role for an entity. For instance, access control analysis component 540 may determine, for the entity, which of one or more applications the entity accesses (such as based on a role of the entity). The analysis component 540 may access repository 530 to determine the least privilege set for each of the one or more applications. The analysis component 540 may then generate the initial least privilege access role for the entity as the union of the privileges in the least privilege set(s) for the one or more applications. The initial least privilege access role may be applied to the entity and govern access to resources for the entity in the data center.

The adaptive permission generator component 550 is configured to refine the initial least privilege access role. The adaptive permission generator component 550 can monitor a real-time resource access pattern of the entity in the data center, such as what resources that entity accesses over a time period, such as a test time period where it is known no threat events are occurring. The adaptive permission generator 550 can utilize the real-time resource access pattern of the entity to refine the initial least privilege access role of the entity, such as removing privilege(s) to access certain resource(s). More specifically, the adaptive permission generator component 550 can utilize the real-time resource access pattern to identify privileges for resources being used and not. Privileges for resources can be removed based on a lack of use of such resources. In this manner, privileges are removed from entities that do not require such privileges. According to one embodiment, the adaptive permission generator component 550 can be implemented as a machine learning model trained to output the least privileges required for an entity.

The permission update component 560 is configured to update the privilege access role for an entity. In this manner, a privilege set produced by the adaptive permission generator component 550 can be used to set the privilege access role.

The various embodiments described herein may employ various computer-implemented operations involving data stored in computer systems. For example, these operations may require physical manipulation of physical quantities. Usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer-readable media. The term computer-readable medium refers to any data storage device that can store data that can thereafter be input to a computer system—computer readable media may be based on any existing or subsequently developed technology for embodying computer programs in a manner that enables them to be read by a computer. Examples of a computer-readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer-readable medium can also be distributed over a network-coupled computer system so that the computer-readable code is stored and executed in a distributed fashion.

Although one or more embodiments have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements or steps do not imply any particular order of operation, unless explicitly stated in the claims.

In accordance with the various embodiments, virtualization systems may be implemented as hosted embodiments, non-hosted embodiments, or embodiments that tend to blur distinctions between the two are all envisioned. Furthermore, various virtualization operations may be wholly or partially implemented in hardware. For example, a hardware implementation may employ a look-up table to modify storage access requests to secure non-disk data.

As described above, certain embodiments involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the preceding embodiments, virtual machines are used as an example for the contexts, and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers.” OS-less containers implement operating system-level virtualization, wherein an abstraction layer is provided on top of the kernel of an operating system on a host computer. The abstraction layer supports multiple OS-less containers, each including an application and its dependencies. Each OS-less container runs as an isolated process in user space on the host operating system and shares the kernel with other containers. The OS-less container relies on the kernel's functionality to make use of resource isolation (CPU, memory, block I/O, network) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory, and I/O. The term “virtualized computing instance,” as used herein, is meant to encompass both VMs and OS-less containers.

Many variations, modifications, additions, and improvements are possible, regardless of the degree of virtualization. The virtualization software can therefore include components of a host, console, or guest operating system that performs virtualization functions. Plural instances may be provided for components, operations, or structures described herein as a single instance. Boundaries between various components, operations, and data stores are somewhat arbitrary, and particular operations are illustrated in the context of specific illustrative configurations. Other allocations of functionality are envisioned and may fall within the scope of the disclosure. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method, comprising:
receiving information regarding two or more threat events that occurred at one or more source systems;
computing, for each of the two or more threat events, a probability of a target system being exploited by the threat event;
selecting, at a first time, a first threat event from the two or more threat events, the first threat event associated with a first probability that meets a threshold;
receiving information regarding one or more remedial actions performed to address the first threat event at a respective source system where the first threat event occurred;
determining, based on the one or more remedial actions, a policy to apply to the target system; and
applying the policy to the target system.

2. The method of claim 1, further comprising:
selecting, at a second time later than the first time, a second threat event from the two or more threat events, the second threat event associated with a second probability that is less than the first probability;
receiving information regarding one or more second remedial actions performed to address the second threat event at a respective source system where the second threat event occurred;
determining, based on the one or more second remedial actions, a second policy to apply to the target system; and
applying the second policy to the target system.

3. The method of claim 1, wherein determining the policy comprises selecting a guardrail from a set of pre-existing guardrails.

4. The method of claim 3, wherein selecting the guardrail from the set of pre-existing guardrails comprises invoking a machine learning model trained on remediation data associated with historical threat events.

5. The method of claim 1, wherein determining the policy comprises generating a guardrail automatically.

6. The method of claim 5, wherein generating the guardrail comprises invoking a machine learning model trained to generate the guardrail based on remediation data associated with historical threat events.

7. The method of claim 1, wherein computing, for each of the two or more threat events, the probability comprises computing a predictive risk score with a weighted equation of two or more input scores.

8. The method of claim 7, wherein the input scores are one or more of a vulnerability assessment tool (VAT) score, a common vulnerability scoring system (CVSS) score, an asset score, a national vulnerability database (NVD) score, a social media score, or a deep web score.

9. A system, comprising:
one or processors coupled to one or more memories that store instructions, that when executed by the one or more processors, cause the system to perform operations comprising:
receiving information regarding two or more threat events that occurred at one or more source systems;
computing, for each of the two or more threat events, a probability of a target system being exploited by the threat event;
selecting, at a first time, a first threat event from the two or more threat events, the first threat event associated with a first probability that meets a threshold;
receiving information regarding one or more remedial actions performed to address the first threat event at a respective source system where the first threat event occurred;
determining, based on the one or more remedial actions, a policy to apply to the target system; and
applying the policy to the target system.

10. The system of claim 9, wherein the operations further comprise:
selecting, at a second time later than the first time, a second threat event from the two or more threat events, the second threat event associated with a second probability that is less than the first probability;
receiving information regarding one or more second remedial actions performed to address the second threat event at a respective source system where the second threat event occurred;
determining, based on the one or more second remedial actions, a second policy to apply to the target system; and
applying the second policy to the target system.

11. The system of claim 9, wherein determining the policy comprises selecting a guardrail from a set of pre-existing guardrails.

12. The system of claim 11, wherein selecting the guardrail from the set of pre-existing guardrails comprises invoking a machine learning model trained on remediation data associated with historical threat events.

13. The system of claim 9, wherein determining the policy comprises generating a guardrail automatically.

14. The system of claim 13, wherein generating the guardrail comprises invoking a machine learning model trained to generate the guardrail based on remediation data associated with historical threat events.

15. The system of claim 9, wherein computing, for each of the two or more threat events, the probability comprises computing a predictive risk score with a weighted equation of two or more input scores.

16. The system of claim 15, wherein the input scores are one or more of a vulnerability assessment tool (VAT) score, a common vulnerability scoring system (CVSS) score, an asset score, a national vulnerability database (NVD) score, a social media score, or a deep web score.

17. One or more non-transitory computer-readable media comprising instructions that, when executed by one or more processors of a computing system, cause the computing system to perform operations comprising:
receiving information regarding two or more threat events that occurred at one or more source systems;
computing, for each of the two or more threat events, a probability of a target system being exploited by the threat event;
selecting, at a first time, a first threat event from the two or more threat events, the first threat event associated with a first probability that meets a threshold;
receiving information regarding one or more remedial actions performed to address the first threat event at a respective source system where the first threat event occurred;
determining, based on the one or more remedial actions, a policy to apply to the target system; and
applying the policy to the target system.

18. The one or more non-transitory computer-readable media of claim 17, wherein the operations further comprise:
selecting, at a second time later than the first time, a second threat event from the two or more threat events, the second threat event associated with a second probability that is less than the first probability;
receiving information regarding one or more second remedial actions performed to address the second threat event at a respective source system where the second threat event occurred;
determining, based on the one or more second remedial actions, a second policy to apply to the target system; and
applying the second policy to the target system.

19. The one or more non-transitory computer-readable media of claim 17, wherein determining the policy comprises selecting a guardrail from a set of pre-existing guardrails.

20. The one or more non-transitory computer-readable media of claim 17, wherein determining the policy comprises invoking a machine learning model trained on remediation data associated with historical threat events.
